(19) United States
(12) Patent Application Publication
(10) Pub. No.: US 2006/0031448 A1
(43) Pub. Date: Feb. 9, 2006

(54) On demand server blades

(75) Inventors: Simon Chu, Chapel Hill, NC (US); Richard Alan Dayan, Raleigh, NC (US); Gregory Brian Pruett, Raleigh, NC (US); David B. Rhoades, Raleigh, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/910,053

(22) Filed: Aug. 3, 2004

(51) Int. Cl. G06F 15/173

(52) U.S. Cl. 709/223

(57) ABSTRACT

A method, system and service for providing on-demand computing power to an owner of a multi-blade computer in a server blade chassis. The server blade chassis is delivered fully populated with server blades to a customer. However, only a portion of the total number of server blades is initially enabled. A management module in the server blade chassis monitors usage of the enabled server blades and associated hardware. If the usage of the enabled server blades exceeds a pre-defined parameter, then additional server blades in the server blade chassis are permanently turned on using the management module and a remotely provided key from the manufacturer of the multi-blade computer.

### BACKGROUND OF THE INVENTION

1. Technical Field

The present invention relates in general to the field of computers, and in particular to multiple blade servers housed in a server chassis. Still more particularly, the present invention relates to a method and system for a providing additional hardware resources to a server chassis based on demand without having to install additional hardware.

2. Description of the Related Art

Server blade computers offer high-density server blades (boards) in a single server blade chassis (blade center chassis computer). A typical server blade computer is illustrated in FIG. 1, identified as server blade chassis 102. Server blade chassis 102 includes multiple hot-swappable server blades 104a-n. There are typically fourteen server blades 104 in server blade chassis 102. The operations of server blades 104 are coordinated by logic identified as management module 106, which typically includes a processor for controlling input/output (I/O) functions, and allocating jobs and data to the different server blades 104.

Typically, each of the server blades contains application software, which is either pre-loaded by the manufacturer of the server blade chassis 102, or else the application software is loaded after hardware delivery by the user/owner.

A main advantage of server blade chassis 102 is that it is scalable. That is, a customer can purchase a server blade chassis 102 that has as many or as few server blades 104 as the customer needs. The customer's needs, however, must be correctly estimated by the customer at the time the server blade chassis 102 is ordered and before hardware delivery. Thus, if the customer underestimates the number of server blades 104 that will be needed, then the server blade chassis 102 is underpowered, and a technician must come to the customer's site to install additional server blades 104, resulting in additional labor and hardware costs associated with installing additional server blades 104. Conversely, if the customer overestimates the number of server blades 104 that will be needed, then resources go unused and wasted.

Therefore, there is a need for a method and system that permits server blades in a server blade chassis to be functionally installed without requiring a technician to physically install new server blades.

### SUMMARY OF THE INVENTION

The present invention is thus directed to a method, system and service for providing on-demand computing power to an owner of a multi-blade computer in a server blade chassis. The server blade chassis is delivered fully populated with server blades to a customer. However, only a portion of the total number of server blades is initially enabled. A management module in the server blade chassis monitors usage of the enabled server blades. If the usage of the enabled server blades exceeds a pre-defined parameter, then additional server blades in the server blade chassis are permanently turned on using the management module and a remotely provided key from the manufacturer of the multi-blade computer.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a prior art multi-blade server chassis;

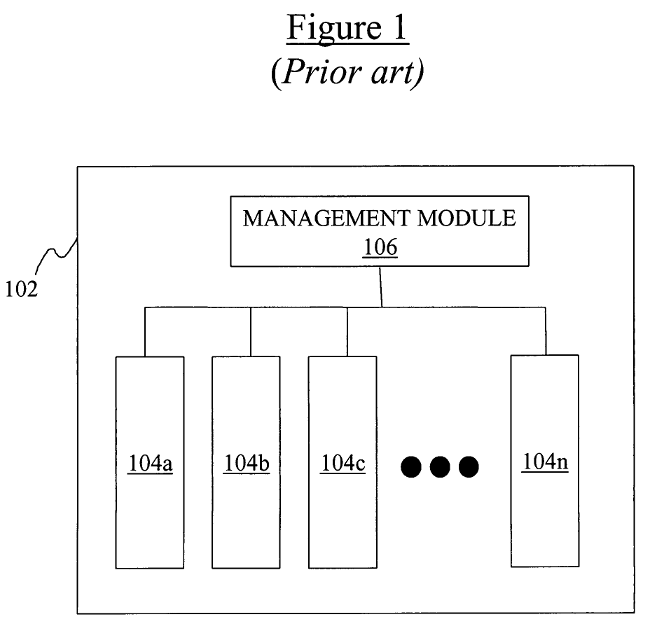

FIG. 2 illustrates a multi-blade server chassis configured to be able to dynamically add additional server blades to the multi-blade server chassis;

FIG. 3 is a flow-chart of steps taken in accordance with the present invention to manage on-demand permanent enablement of server blades in a multi-blade server chassis; and

FIG. 4 is an exemplary graphical user interface (GUI) allowing an owner/operator of the multi-blade server chassis a choice in whether to enable a new server blade.

### DETAILED DESCRIPTION OF THE PREFERRED EMBODIMENT

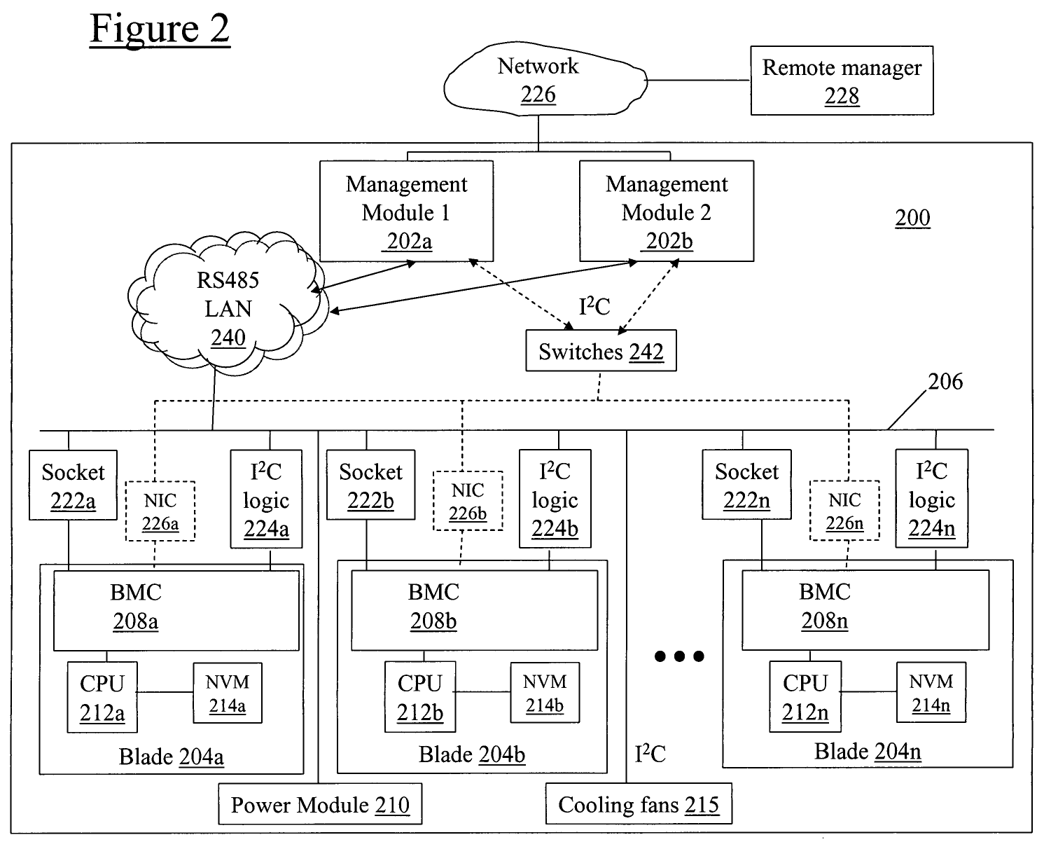

With reference now to FIG. 2, there is depicted a schematic block diagram of a server blade chassis 200 according to a preferred embodiment of the present invention. For the sake of clarity, only three server blades 204a, b, n are depicted. However, in a preferred embodiment, server blade chassis 200 has a midplane 206 capable of connecting fourteen or more server blades 204.

Server blade chassis 200 has one or more management modules 202. As depicted, server blade chassis 200 has a primary management module 202a and a back-up management module 202b. Each management module 202 is capable of managing multiple server blades 204. During normal operations, one of the local management modules 202a or 202b is coupled to server blades 204a-n via a Local Area Network (LAN) 240, a midplane 206, and a plurality of Baseboard Management Controllers (BMCs) 208 (each server blade 204 having a BMC 208) to form an in-band management pathway.

Midplane 206 is a backplane, mounted in the middle of server blade chassis 200, that contains circuitry and sockets 222 into which additional electronic devices or cards, including server blades 204 can be plugged. Midplane 206 contains at least one bus for secure in-band internal communication between management module 202 and server blades 204a-n, as well as between and among server blades 204a-n themselves, via respective BMCs 208a-n.

When a server blade 204 is plugged into a specific socket 222, a physical address is established for that server blade 204. For example, consider server blade 204a being plugged into socket 222a. A control logic, depicted as I²C logic 224a, which is compliant with the Phillips' Inter-IC (Inter-Integrated Circuit) standard (incorporated by reference in its entirety herein and commonly referred to as “I²C”), detects the presence of server blade 204a in socket 222a. I²C logic 224a, operating in conjunction with management module 202, assigns a physical address on a bus in midplane 206 to server blade 204a when server blade 204a is plugged into socket 222a. Preferably, each server blade 204 is associated with a unique I²C logic 224, which is preferably connected to midplane 206 as depicted in FIG. 2. Alternatively, all server blades 204 can use a single I²C logic 224.

Alternatively, each server blade 204 may have a unique Internet Protocol (IP) address on midplane 206. That is, midplane 206 may support intercommunication using IP addressing protocol, in which each device connected or coupled to midplane 206 contains an IP address assigned by logic (not shown) that is either within or outside server blade chassis 200. For example, a Dynamic Host Configuration Protocol (DHCP) server (not shown) may be used to assign an IP address to server blade 204a. Communication with server blade 204a is thereafter via a Network Interface Card (NIC) 226a that is associated with server blade 204a. Server blades 204 having an IP address can then communicate to a network 226 outside server blade chassis 200 via an out-of-band network using switches 242.

Each server blade 204 has at least one central processing unit (CPU) 212, and a non-volatile memory (NVM) 214. Preferably, NVM 214 is a Flash Read Only Memory (“Flash ROM” or “Flash Memory”), which can be erased and reprogrammed in units of memory called blocks. NVM 214 may also include non-volatile Electrically Erasable Programmable Read Only Memory (EEPROM), which is similar to Flash Memory except that EEPROM is erased and rewritten at the byte level, and is usually smaller in capacity than the flash memory.

When a server blade 204 is shipped from a manufacturer, the NVM 214 is typically pre-burned with firmware, including a Basic Input/Output System (BIOS) as well as software for monitoring the server blade 204. Such monitoring may include controlling Direct Access Storage Devices (DASD's), monitoring and controlling voltages throughout the system, determining the power-on status of the server blade 204, requesting access to a shared keyboard, video, mouse, Compact Disk-Read Only Memory (CD-ROM) and/or floppy disk drives, as well as monitoring the Operating System (OS) running on the server blade 204.

As depicted, each server blade 204 has a Baseboard Management Controller (BMC) 208, which provides local supervisory control of the server blade 204 to which it is associated. Each BMC 208 is able to communicate with a local management module 202 by either using LAN 240 (in-band network) or alternatively by using switches 242 and NICs 226 (out-of-band network).

LAN 240 is an in-band network, preferably comporting with the Electronics Industry Association (EIA) RS485 Standard for data communication. Management modules 202 (either primary management module 202a or back-up management module 202b if management module 202a is down) communicate via LAN 240 with BMC 208, which includes logic for coordinating communication with server blades 204 via sockets 222. That is, the primary communication pathway between management module 202 and server blades 204 is the in-band network that comprises LAN 240, sockets 222, and BMC 208. The secondary communication pathway is the out of band network that comprises switches 242 and NICs 226.

Management module(s) 202 can communicate with a remote manager 228 via network 226, such as the Internet. Remote manager 228 is a computer system that allows a remotely located systems engineer to communicate with server blade chassis 200.

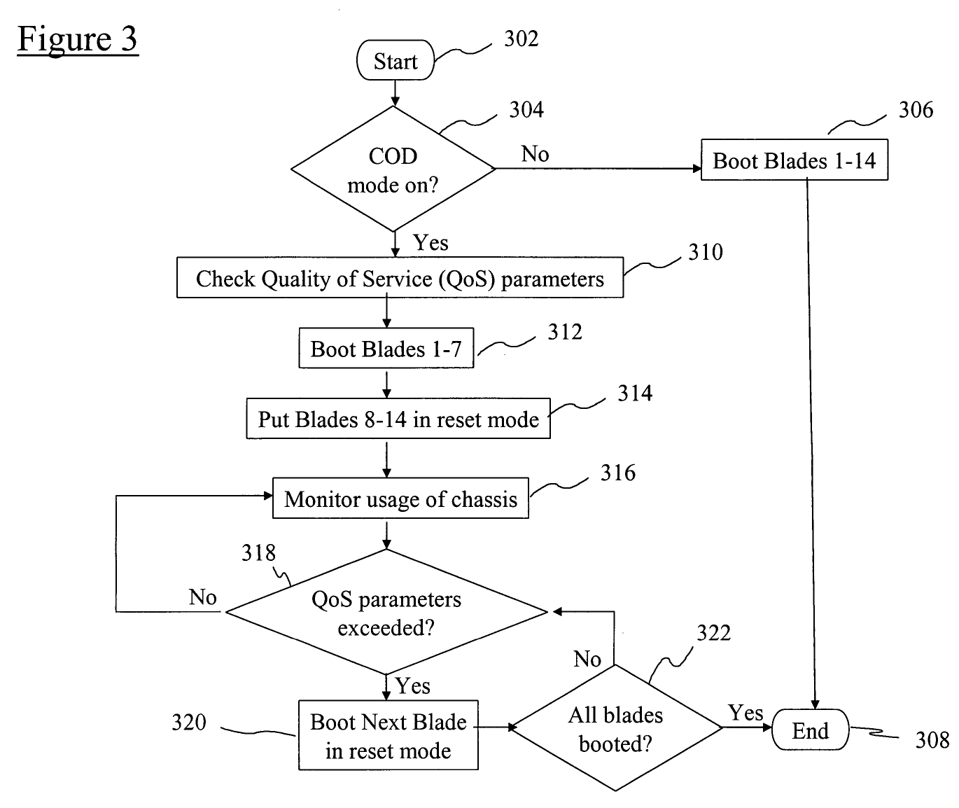

With reference now to FIG. 3, a flow-chart of steps taken in the present invention is presented. After initiator block 302, a query is made as to whether a Capacity On Demand (COD) mode is turned on for the server blade chassis (block 304). That is, the management module contains software indicating whether additional server blades in the server blade chassis subsequently are authorized to be enabled. Alternatively, if the COD mode is not turned on, then all server blades (typically 14 in number) in the chassis are booted at start-up (block 306), and the process ends (terminator block 308).

However, if the COD mode is turned on, then the Quality of Service (QoS) parameters are checked (block 310). The QoS parameters describe what performance capability a user has decided ahead of time to have and pay for in the server blade chassis system. That is, the user can define, using software such as IBM's Director™, desired parameters such as how many hits a website can support in a day, CPU utilizations, network bandwidth and consumption, memory usage, response time to web requests, etc.

Based on the selected QoS number and upon the purchased policies chosen by the customer, the management module initially boots up some, but not all, of the server blades that populate the server blade chassis (block 312). For example, upon initial start-up, server blades 1-7 could be booted up. Concurrently, the rest of the server blades (e.g., server blades 8-14—block 314) are put in a reset mode, which does not permit them to be active, but does allow them to be enabled later as described below.

Next, usage of the server blade chassis and its server blades is monitored (block 316), preferably by the management module, or alternatively, by the remote manager. Usage that is monitored is the QoS parameters that include, but are not limited to, CPU utilization, internal and external network bandwidth and bandwidth consumption, memory usage, response time to web requests, etc. That is, the performance specifications of the multi-blade computer is monitored and compared with the pre-determined pre-defined QoS parameters set by the customer who owns and/or operates the multi-blade computer. These QoS parameters are in initial compliance with the hardware enabled in the multi-blade computer. For example, seven server blades may be able to initially accommodate the QoS parameters. However, if these QoS parameters are later exceeded, then additional server blades need to be enabled.

Thus, a query is made as to whether the QoS parameters have been exceeded (query block 318). If so, then a next server blade is booted up out of reset mode (block 320). If all server blades in the server blade chassis have been booted (block 322), then the process ends (terminator block 308). Otherwise, a query is made as to whether the QoS parameters are still being exceeded (query block 318), and a next server blade is booted up out of reset mode (block 320). Thus, as many new server blades as necessary to meet the QoS parameters are booted up.

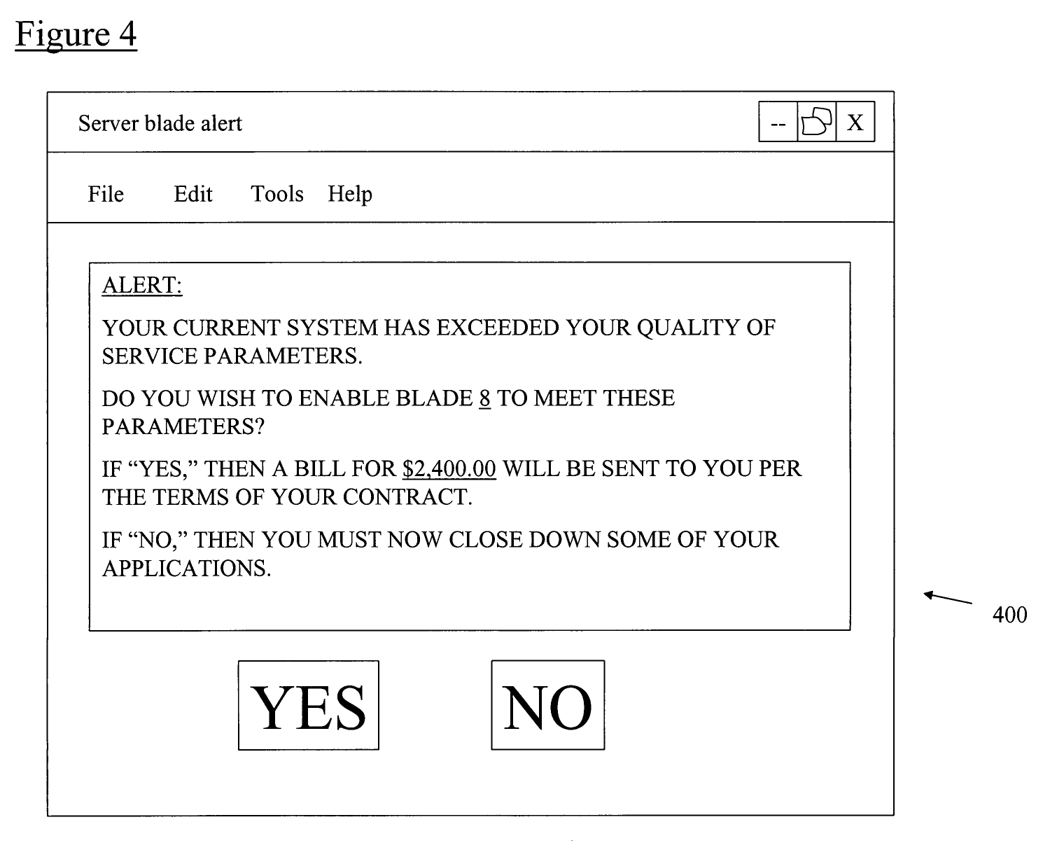

In a preferred embodiment, the step of booting up a next server blade is preceded by an alert step (not shown). An alert is sent to the owner/operator of the server blade chassis that one or more new server blades need to be enabled to meet the requirements of the QoS parameter. This alert will give the owner/operator an option, as shown as graphical user interface (GUI) 400 in FIG. 4, whether he wishes to enable the new server blade(s), along with the cost of doing so. If the owner/operator decides to enable the new server blade, then the remote manager is so notified, and the remote manager sends a bill to the owner/operator for the cost of the newly enabled server blade. The cost may be the cost of the server blade at the time of initial delivery of the server blade chassis system, or it may be a present day cost of the server blade. In either case, the cost obviously does not include any shipping or labor costs, but may include an offset to compensate the manufacturer for the cost of allowing the owner/operator to possess the unused server blades and to authorize the use of the newly enabled blade. If the owner/operator does not want to enable a new server blade, then he will be advised to shut down one or more applications.

If the user/owner of the server blade chassis wishes to enable one or more server blades, then upon receiving a “YES” signal from the GUI 400, an authorization signal is sent from the remote manager to the out-of-band management module. This authorization signal, which preferably is a password, key, or any other secure signal, authorizes and enables the out-of-band management module to enable the new server blades.

The present invention therefore provides a way for an owner/user of a multi-blade computer system to pre-store server blades in a server blade chassis, without having to pay for them until and unless he needs them. The server blades are then permanently enabled without the requirement of a service call from a technician to install new server blades, or even shipping the new server blades. Since most enterprises eventually increase workload demands on server systems, the server blades would rarely go unused forever. Note that in one of the preferred embodiments, ownership of the multi-blade computer system is transferred from a supplier of the multi-blade computer system to a user/customer of the multi-blade computer system.

In addition to the method and service described above, the server blades can also be disabled if the usage of the server blade chassis drops below the original pre-determined QoS parameters. If so disabled, it is significant that the server blade chassis is available for use only by a current owner of the server blade chassis, and thus is not a lease to the general public.

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method comprising:
fully populating a multi-blade server chassis with server blades, the multi-blade server chassis having a management module and a switch to allow external communication with a network that is external to the multi-blade server chassis;
initially enabling less than all of the server blades;
monitoring usage parameters for the multi-blade server chassis when using the enabled server blades; and
in response to the multi-blade server chassis exceeding a pre-determined parameter, permanently enabling one or more additional server blades previously populated in the multi-blade server chassis.

2. The method of claim 1, wherein the management module initially enables less than all of the server blades according to the pre-determined parameter.

3. The method of claim 1, wherein the additional server blades are permanently enabled by the management module in response to the management module receiving an authorization signal from a remote location.

4. The method of claim 1, further comprising:
prior to one or more additional server blades being permanently enabled, transmitting an alert to a user of the multi-blade server chassis that an additional server blade needs to be enabled, and waiting for an authorization from the user before enabling the additional blade server.

5. The method of claim 4, further comprising transmitting to the user a bill for the one or more additionally enabled server blades for an amount based on a hardware present value of the additionally enabled one or more server blades is transmitted.

6. The method of claim 4, further comprising transmitting to the user a bill for the one or more additionally enabled server blades for an amount based on a hardware value of the additionally enabled one or more server blades at the time the multi-blade server chassis was delivered.

7. The method of claim 1, wherein at least one of the server blades is able to function independently of the rest of the server blades in the multi-blade server chassis.

8. The method of claim 1, wherein the one or more additional server blades are enabled when the multi-blade server chassis exceeds multiple pre-determined parameters.

9. A system comprising:
a fully populated multi-blade server chassis having multiple server blades, the multi-blade server chassis having a management module and a switch to allow external communication with network that is external to the multi-blade server chassis, the management module being capable of:
initially enabling less than all of the server blades;
monitoring usage parameters for the multi-blade server chassis when the multi-blade chassis uses the enabled server blades; and
in response to the multi-blade server chassis exceeding a pre-determined parameter, permanently enabling one or more additional server blades previously populated in the multi-blade server chassis.

10. The system of claim 9, wherein the management module initially enables less than all of the server blades according to the pre-determined parameter.

11. The system of claim 9, wherein the additional server blades are permanently enabled by the management module in response to the management module receiving an authorization signal from a remote location.

12. The system of claim 9, wherein the management module, prior to one or more additional server blades being permanently enabled, transmits an alert to a user of the multi-blade server chassis that an additional server blade needs to be enabled, and waits for an authorization from the user before enabling the additional blade server.

13. The system of claim 12, wherein the management module transmits to the user a bill for the one or more additionally enabled server blades for an amount based on a hardware present value of the additionally enabled one or more server blades is transmitted.

14. The system of claim 12, wherein the management module transmits to the user a bill for the one or more additionally enabled server blades for an amount based on a hardware value of the additionally enabled one or more server blades at the time the multi-blade server chassis was delivered.

15. The system of claim 9, wherein at least one of the server blades is able to function independently of the rest of the server blades in the multi-blade server chassis.

16. A service comprising:
fully populating a multi-blade server chassis with server blades, the multi-blade server chassis having a management module and a switch to allow external communication with a network that is external to the multi-blade server chassis;
initially enabling less than all of the server blades;
monitoring usage parameters for the multi-blade server chassis when using the enabled server blades; and
in response to the multi-blade server chassis exceeding a pre-determined parameter, permanently enabling one or more additional server blades previously populated in the multi-blade server chassis.

17. The service of claim 16, wherein the management module initially enables less than all of the server blades according to the pre-determined parameter.

18. The service of claim 16, wherein the additional server blades are permanently enabled by the management module in response to the management module receiving an authorization signal from a remote location.

19. The service of claim 16, further comprising:
prior to one or more additional server blades being permanently enabled, transmitting from the remote manager an alert to a user of the multi-blade server chassis that an additional server blade needs to be enabled, and waiting for an authorization from the user before enabling the additional blade server.

20. The service of claim 19, further comprising transmitting from the remote manager to the user a bill for the one or more additionally enabled server blades for an amount based on a hardware present value of the additionally enabled one or more server blades is transmitted.

21. The service of claim 19, further comprising transmitting from the remote manager to the user a bill for the one or more additionally enabled server blades for an amount based on a hardware value of the additionally enabled one or more server blades at the time the multi-blade server chassis was delivered.

22. A service comprising:
fully populating a multi-blade server chassis with server blades, the multi-blade server chassis having a management module and a switch to allow external communication with a network that is external to the multi-blade server chassis;
transferring ownership of the multi-blade server chassis from a supplier to a user;
initially enabling less than all of the server blades;
monitoring usage parameters for the multi-blade server chassis when using the enabled server blades; and
in response to the multi-blade server chassis exceeding a pre-determined parameter, enabling one or more additional server blades previously populated in the multi-blade server chassis.

23. The service of claim 22, wherein the additional one or more server blades are available only to the user of the server chassis.

24. The service of claim 23, further comprising:
disabling one or more of the server blades in response to usage of the server chassis dropping below the pre-determined parameter.
